(19) United States
(12) Patent Application Publication
(10) Pub. No.: US 2026/0097544 A1
(43) Pub. Date: Apr. 9, 2026

(54) HOT RUNNER INJECTION NOZZLE SYSTEM SUITABLE FOR CO-INJECTION MOLDING WITH BUILT-IN OBTURATOR AND VARIABLE GATE DIRECTION

(71) Applicant: PLASDAN - AUTOMAÇÃO E SISTEMAS, LDA, Marinha Grande (PT)

(72) Inventor: Paulo Juliano PEREIRA DA SILVA ARAÚJO, Marinha Grande (PT)

(21) Appl. No.: 19/112,437

(22) PCT Filed: Jul. 27, 2023
(86) PCT No.: PCT/IB2023/057649

§ 371 Date: Mar. 17, 2025

(30) Foreign Application Priority Data
Sep. 30, 2022 (PT) 118238

(51) Int. Cl. B29C 45/16; B29C 45/27

(52) U.S. Cl. CPC B29C 45/1604; B29C 45/2708

(57) ABSTRACT

A hot runner injection nozzle system for use in co-injection molding with a built-in obturator valve (7) in a nozzle tip assembly (16) attached to a nozzle body (1) and permits several different directions of gating. It allows for independent flow of each melt stream having their confluence at the very last possible position avoiding mutual contamination with the built-in obturator (7). The nozzle tip assembly comprises several channels providing for the flow of multiple polymeric melt streams and an obturator that serves as a check valve. Selective flow of each stream is fully controlled by individual injection units at the source providing the feed for each melt stream. The invention allows for simple fabrication, maintenance, reduces mutual contamination and allows for a more compact hot runner manifold and tool design. It allows for an optional needle-valve when the product requires a better injection point finish.

### TECHNICAL FIELD

The present application relates to a hot runner injection nozzle system that is suitable for co-injection molding of modular construction.

### BACKGROUND ART

In the process known, in the plastic injection molding industry, as co-injection molding, the parts or goods are produced using different types of materials, at least two, in which one of them forms an external layer 1 or skin, encapsulating the other one in the core of the part body. The co-injection process is extremely adequate to the use of recycled materials that can be injected in the core of the parts without affecting their structural characteristics or their external surface visual aspect.

The core can also be comprised of engineering materials that impart properties like spring action and barrier properties among several possibilities.

Significant economy of resources can be achieved using this process for several reasons. Among these are:
the use of cheaper materials in the core;
incorporate the core with engineered polymers;
the reduction of color pigments or external lubricants, that will be used only in the external layer;
the use of expensive barrier material only in the core to enhance product properties;
use of foaming materials in the core to reduce weight and allow for thicker walled parts;
incorporate a large percentage Post Consumer Resin (PCR);
reduced quantity of skin material with special properties for further processing (like painting);
generate products with two distinct volumes of materials at different sections.

The process consists in a sequence of injection shots of melted polymers into the mold cavity through a common cavity gate. The polymers are melted and injected by individual injection units through dedicated sprue gates. The respective melt streams of each material flow along individual channels in hot-runner manifolds in the direction of the injection hot-runner nozzle body. The hot-runner nozzle body in turn supplies the hot-runner nozzle tip through multiple inlet ports, one or more for each material, and the streams are channeled convergent to a common orifice located at the mold cavity entry gate.

The dispensing of a needle-valve effects a significant reduction in mold height making it more compact and sometimes detrimental in defining the size of injection molding machine. Needle-valves normally require hydraulic or pneumatic actuating mechanisms which occupy space behind the manifold which adds to the height of the mold. Compact lateral gating is also made possible as the needle-valve is dispensable making for easier accommodation of the hot runner injection nozzle body and nozzle tip/s. Hence multiple cavities can be conceived in a compact space with co-injection molding. To our knowledge this capability for lateral co-injection is not available and vital for many components that require to be co-injected and maintain the economy in mold size as well as the injection molding machine.

During the filling part of the molding cycle, the melted polymers are injected, one during the entire time and the other for a shorter time in-between through the same gate into the cavity. The first one will be the external or skin material and a thin boundary layer of this solidifies when in contact with the cold walls of cavity. The core of this first injection stays in molten state, cooling slower, in a time, dependent on heat conductivity of the polymer. This delay in the solidification allows the second stream of melt to flow, through the still soft or molten material, to form the core of the part.

Because both convergent channels are in communication near the cavity gate, the molten material that is being injected into the mold cavity can invade the melt channel of the other material, along its channels crossing the manifold up to its entry sprue. This means that both melt flows can be significantly contaminated. This contamination has visible effects on the surface of the molded part. The first material or the skin material drags and pushes into the cavity the second material which previously invaded its channels and also the second material remaining in the flow channels junction downstream.

During the core filling, the core material may also invade the channels of skin material and the contaminated material will be used in the final cycle step which is the final shot of skin material to close the envelope or the external surface layer of molded part.

The referred mutual contamination highly affects the parts quality and to reduce its effect it becomes necessary to realize frequent purging and expensive operations to clean nozzles and manifolds. In order to reduce the magnitude of this problem the mold makers install check valves or needle-valve or other type of unidirectional flow control valves for opening/closing the feeding holes at the manifold before the inlet ports of convergent holes of the hot runner nozzle before their confluence near its tip. Despite this, the downstream length of channel, from the location of the referred valves, installed into the manifold, up to the cavity gate is long and so the contamination is still significant and can be problematic.

The effects of mutual contamination are particularly difficult to eliminate by purging when dealing with materials that have varying viscosity and melting points.

### SUMMARY

The invention presented in this application is a solution to the problems described before. The integration of an obturator that serves as a check valve inside the hot runner nozzle body very near the tip of the nozzle reduces the residual contamination to an extremely small volume, which is easily nullified during the last material shot, because the contaminated volume will stay in the core of the molded parts.

The present application relates to a hot runner injection nozzle system that allows for the simultaneous flow of multiple polymeric melt streams through a single opening on one free end for the co-injection of products. This is characterized by comprising of at least one of:
Injection nozzle body which provides the connection and channels for the melt streams between the hot runner manifold and the injection nozzle tip. It will be connected to the nozzle tip with adequate fixing. For better explanation from here on the flow of the melt stream towards the extrusion gate to the cavity will be referred to as being downstream and upstream for the reverse direction.

In one embodiment attached to the nozzle body, the nozzle tip assembly will multiply the number of channels delivering the molten stream of each polymer to the cavity gate.

In one embodiment between the adapter plate of the nozzle tip assembly and the nozzle body, in an appropriate channel will be located a part of adequate shape and with freedom of movement from one side of the channel to the other and will serve as an obturator/check valve permitting only for downstream flow and prevent contamination upstream. Difference in pressure between the streams will determine its position hence preventing the mutual contamination upstream.

In one embodiment the nozzle tip assembly comprises an assembly of bodies with several flow channels to direct the flow of individual melt streams towards the extrusion gate into the cavity and the confluence point of all streams at the entrance to the molding cavity downstream.

In one embodiment one of the streams is directed towards the exterior of the tip and subsequently towards the gate. The other stream flows towards the center of the tip and subsequently through the gate. The Polymeric cap will add thermal insulation and allow for thermal expansion having adequate compressive flexibility.

In another embodiment the nozzle tip is at an angle to the injection nozzle body axis. This is to allow the tool designer the liberty to project a lateral injection, hence permitting alternate injection points and still using the co-injection principle. In this embodiment, shown here at a ninety-degree angle only for better illustration and by no means limiting, the housing is fitted with an additional manifold which will channel the melt stream to the nozzle tips which in turn channel the melt streams towards a lateral gating into the mold cavity. In this embodiment the nozzle tip assembly are as previously described in a previous embodiment. The disposition and number of nozzle tip assemblies can vary, some of which in, rectangular, circular or triangular patterns. The additional manifold is endowed with adequate heating and thermocouples to ensure efficient melt flow within the prescribed parameters.

In another embodiment the co-injection nozzle system is endowed with a needle-valve basically to fulfill the requirements of the final product for a better finish, i.e., obliterate injection point mark on the part. In this embodiment the injection nozzle body, adapter block and nozzle tip are fabricated to accommodate a center hole for the needle-valve. The nozzle body will also accommodate an additional part to serve as a guide for the needle-valve.

In another embodiment, the nozzle tip besides the needle-valve will contemplate an additional channel for the skin material hence dispensing three melt streams to the confluence point at the cavity gate. A three-layer nozzle tip allows for better control of the core layer in terms of thickness and relative position. The tip will have a sliding obturator which is in the shape of a cylinder with one rounded end and slides along the needle-valve axis direction, rather than a sphere. This will impede the mutual contamination of melt streams.

However, it should be noted that the needle-valve is an option for both two-and three-layer injection nozzles and not an absolute necessity.

### General Description

The present application refers to a system that permits the co-injection molding of products through extrusion gates parallel or angular to the injection molding machine axis with or without a needle-valve. The optional use of the needle-valve and with a built-in obturator, is exactly what permits an efficient co-injection without the danger of mutual contamination. The obturator's position is based on the difference in pressure of the melt streams. The mold height is reduced as there is no requirement for the needle-valve and its actuation device which can be detrimental to defining size of the injection molding machine.

One channel which is fed with core material and the other with the skin material. Both materials are injected sequentially into the cavity through the same orifice at the cavity gate. The melt streams remain isolated until the very last possible confluence point at the entrance to the molding cavity gate.

A needle-valve can be accommodated to permit a better finish on the final part obliterating the mark of the injection point on the final molded article. The combination of operating states of the obturator/check-valve allows the full mutual replacement of polymers flowing through the common injection gate, creating the conditions for clean injection of combined skin and core layers.

Usually, the industry applies open hole nozzles and the solution used to reduce the contamination of skin layer by the core material consists in the assembly of another needle-valve or in the assembly of a set of check valves inside the hot runner manifold. These solutions imply, however, longer channels from the point where these devices are inserted in the manifolds to the tip of the nozzle and then the probability of contamination is higher. The probability increases in the case of materials with different viscosity indexes. This contamination is very difficult to eliminate, and the cleaning of the runners only can be done with frequent and costly purging operations. The integration of the check valve into the invented nozzle tip body prevents such contamination.

### BRIEF DESCRIPTION OF DRAWINGS

The features, advantages and application of the invention will be foregoing and apparent form the following description and illustration of embodiments as included in this document. The drawings form a part of the specification and serve the purpose of explaining the principles and functioning of the invention and enable any person skilled in this art to understand and make use of the invention and will be referenced during the description of the embodiments.

FIG. 1—Sectioned isometric view of an embodiment of the hot runner injection nozzle system, showing all main components and internal melt flow channels together with the hot runner manifold and sprues.

FIG. 2—Exploded view of an embodiment in a straightforward application.

FIG. 3—Front sectional view of an embodiment of the hot runner injection nozzle system with an optional polymeric cap.

FIG. 4—Detail A as shown in FIG. 3.

FIG. 5—Front sectional view of an embodiment of the hot runner injection nozzle system without the polymeric cap.

FIG. 6—Detail A as shown in FIG. 5.

FIG. 7—Shows the shape of the flow channels for the individual melt streams.

FIG. 8—Shows various options for lateral injection of products. FIG. 8A shows a circular shape and disposition of a four-drop lateral injection; FIG. 8B shows a rectangular shape and disposition of a four-drop lateral injection; FIG. 8C shows a rectangular shape and disposition of a two-drop lateral injection.

FIG. 9—Sectional views of a two-drop lateral injection nozzle showing details of the flow channels and obturator/check valve. FIG. 9A is a lateral view section A-A and FIG. 9B is a top view section D-D.

FIG. 10—Front and sectional view of an embodiment in a circular shape and disposition for four cavities. FIG. 10A shows a front view and FIG. 10B shows a section A-A as defined in FIG. 10A.

FIG. 11—Isometric sectional view of an embodiment with added needle-valve.

FIG. 12—Detail of the nozzle tip for an embodiment with additional needle-valve. FIG. 12A shows a cross section view, FIG. 12B shows detail B.

FIG. 13—Shows a three-layer injection nozzle with a needle-valve.

FIG. 14—Shows details of the three-layer nozzle tip. FIG. 14A shows a cross section view, FIG. 14B shows detail C.

FIG. 15—Shows another cross-section perpendicular to the previous figure and shows some more detail of the melt channels. FIG. 15A shows a cross section view, FIG. 15B shows detail D.

FIG. 16—Shows the shape of the flow channels for the individual melt streams on a three-layer co-injection nozzle system.

FIG. 17—Shows an embodiment of the hot runner injection nozzle system.

### DESCRIPTION OF EMBODIMENTS

Now, preferred embodiments of the present application will be described in detail with reference to the annexed drawings. However, they are not intended to limit the scope of this application.

The terms and designation used in the description correspond to the most common used in the industry and injection molding technology for polymer materials. This description will not be limited by theory related to the different scientific and technological fields related to injection molding.

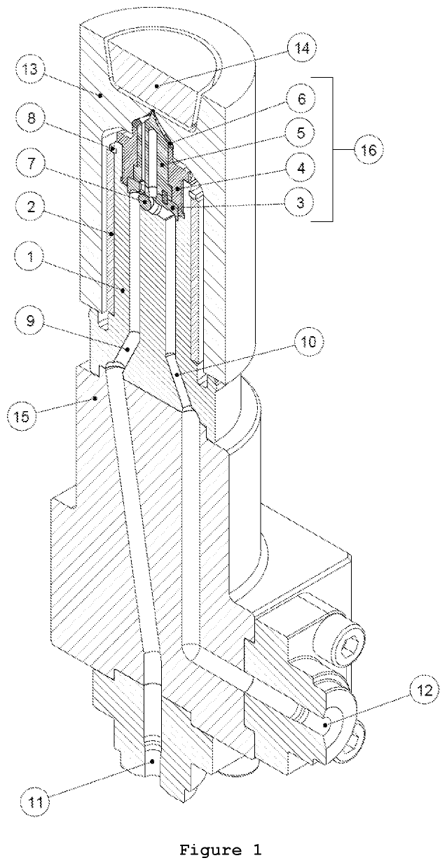

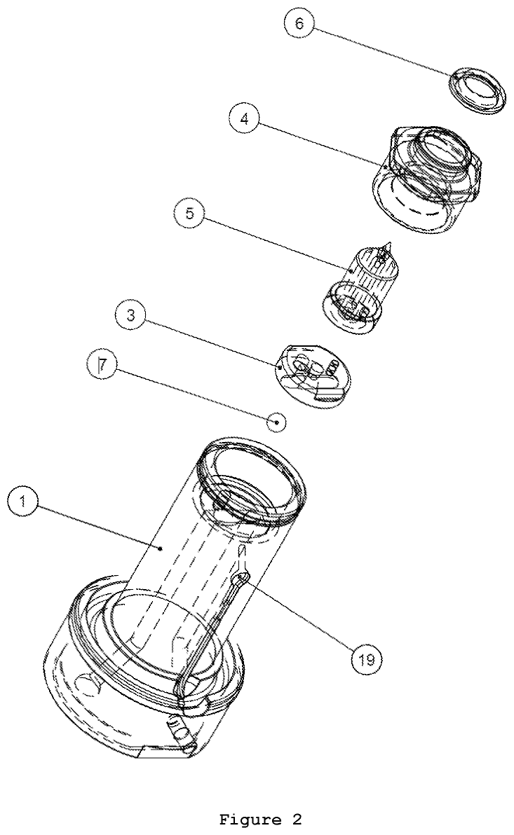

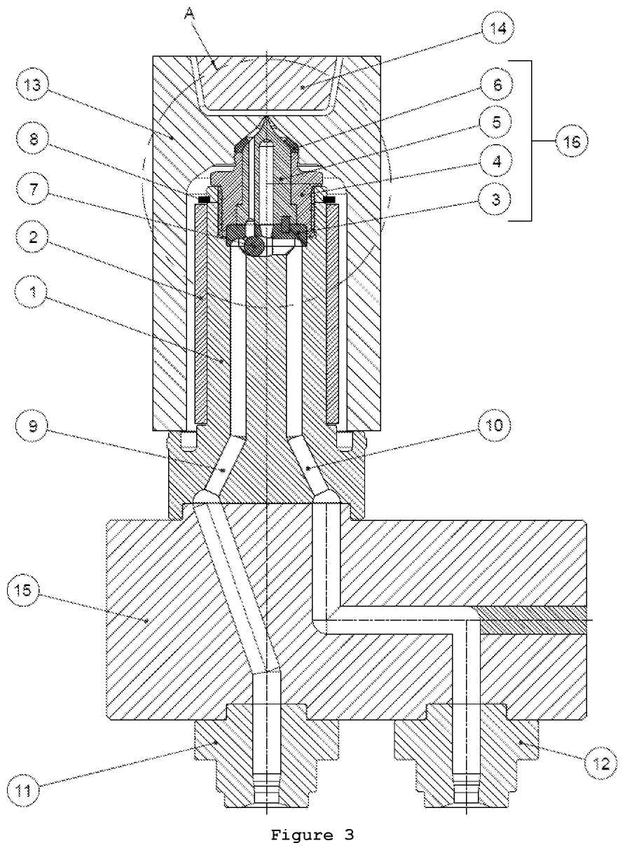

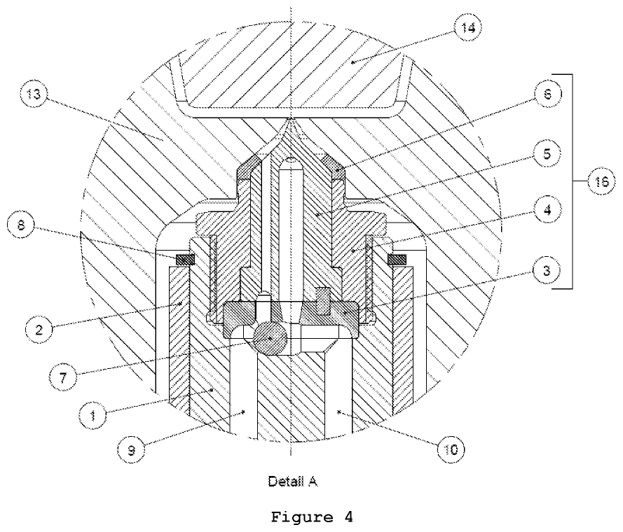

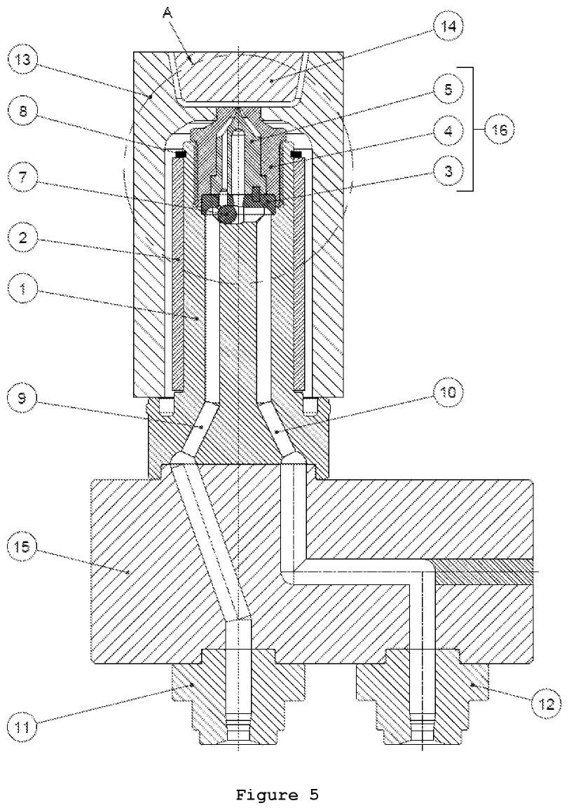

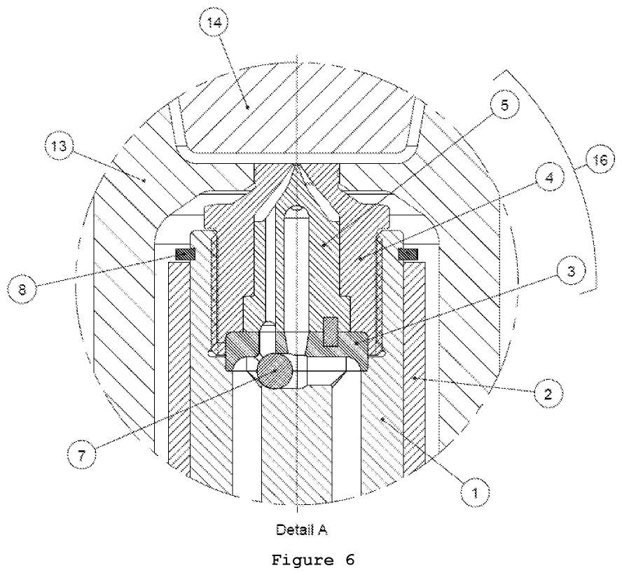

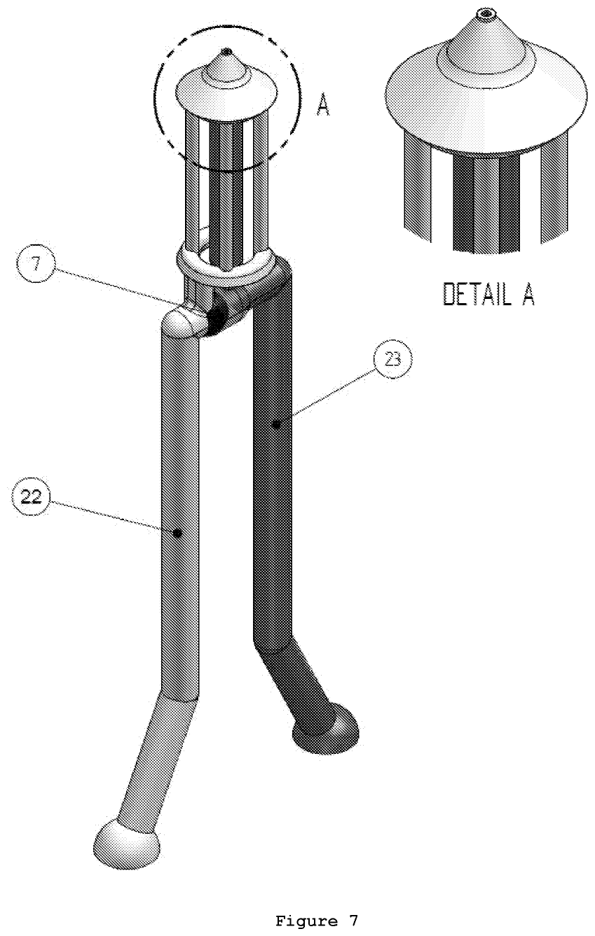

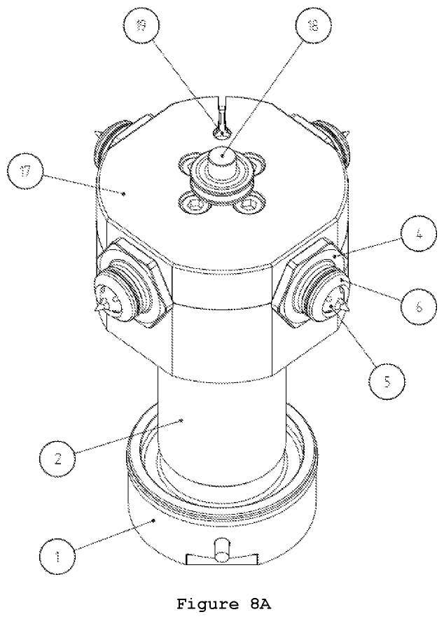

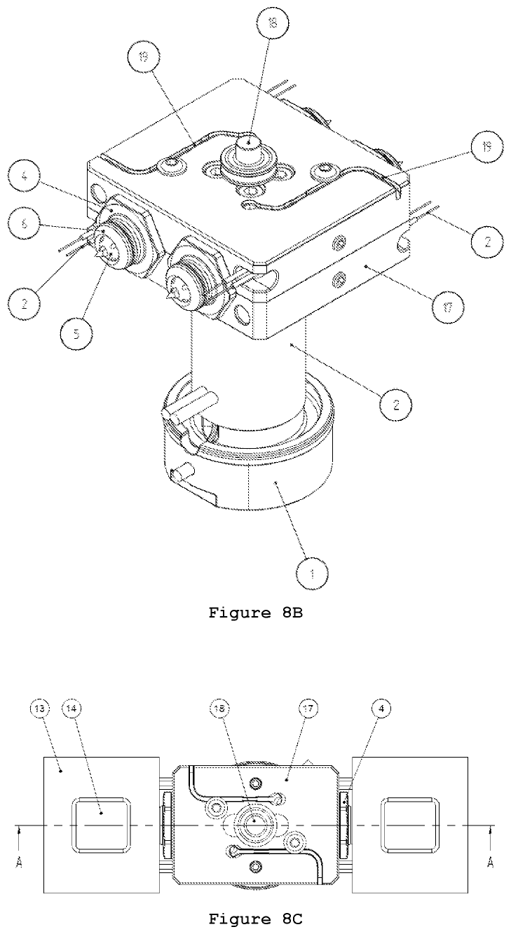

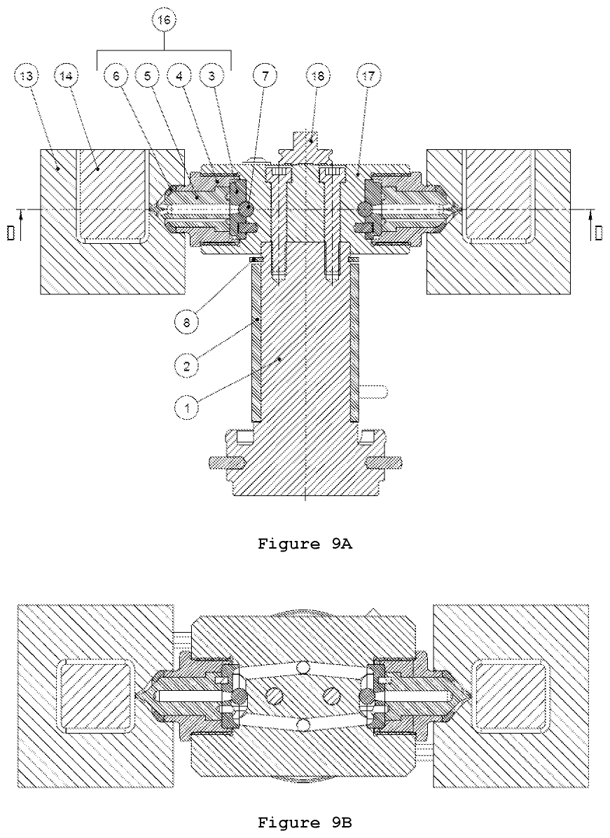

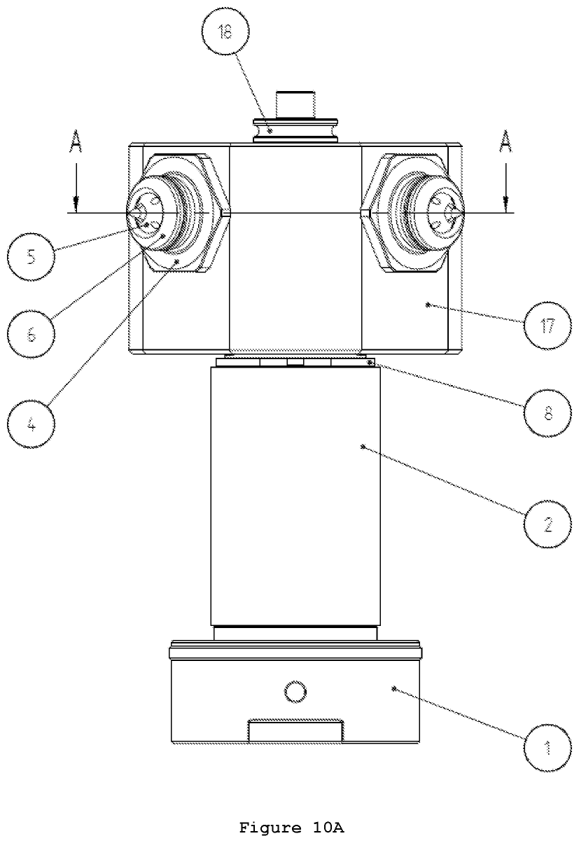

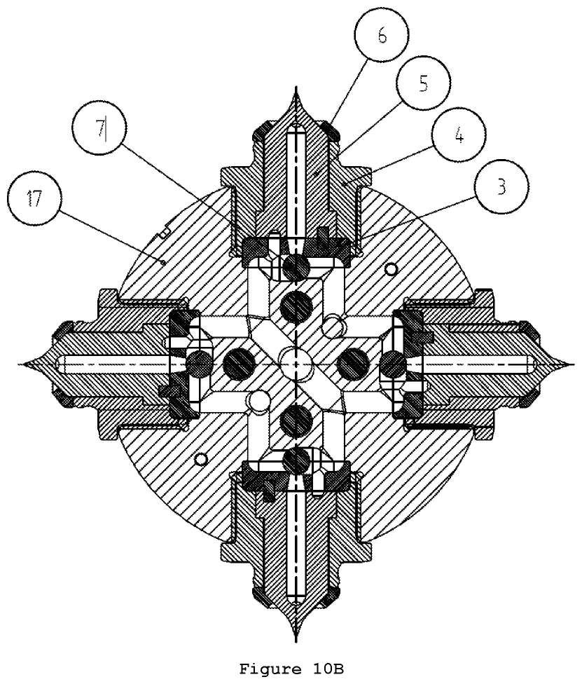

The disclosed technology is suitable for co-injection of most polymers. Whenever there is a need for a multi layered product which is co-injected, the presented technology will fulfil the required specifications as well as retain the mutual protection from contamination of the individual polymer melt streams. The obturator/check-valve is the key feature in the presented technology which makes it unique and allows for nozzle tips which dispense the need for a needle-valve. This in turn allows for the direction of gating to vary from straight-forward (FIGS. 1 through 7) to lateral injection (FIGS. 8 to 10). The change from one to the other has a common interface whereby manufacturing is kept standard, and assembly gives the different options.

### Preferred Embodiment

Each melt stream has an individual source with all the feeding controls like start/stop, speed, temperature, pressure, etc. These melt streams are then fed and channeled (FIG. 1, to 7 and FIG. 17) through the hot runner manifolds (15) to the injection nozzle body (1). The injection nozzle body (15) has individual channels inlet channel A (9) and inlet channel B (10) aligned with the hot runner manifold (15) outlets to receive the melt stream previously fed to the manifold by sprue A (11) and sprue B (12) respectively. Each melt stream then flows through individual channels upstream towards the nozzle tip assembly (16). One of the melt streams, usually the skin material, in the nozzle tip assembly (16) is redistributed through additional channels and then re-unites at the conical tip to flow towards the gate and out into the molding cavity (13). The other melt stream, usually the core material, is directed towards the center of the nozzle tip assembly (16) and subsequently towards the gate and out into the molding cavity (13). Between the injection nozzle body (1) and the nozzle tip assembly (16) there is a common channel which houses an obturator/check valve (7) of adequate shape which is suitable to slide towards either melt stream port according to the pressure exerted by each. The nozzle tip assembly (16) comprises an adapter plate (3) that adds the necessary channeling elements and simplifies manufacturing. The channeling elements are a plurality of channels output that houses parts of the obturator/check valve (7) and the inner insert (5). It also includes a lock nut (4) suitable to hold the nozzle tip assembly (16) positioned and in place, an inner insert (5) which is suitable to provide additional channeling. The prescribed heat is provided by a heating element (2) fixed by a circlip (8) to maintain the temperature of the melt stream in the nozzle and is controlled by a thermocouple adequately positioned and lodged in a thermocouple lodging (19). Hence through the gate this application will allow for simultaneous flow of both or individual melt streams.

In this embodiment, the hot runner nozzle system of the present invention has an injection nozzle body (1) enveloped by a heating element (2) that is fixed by a circlip (8) and comprises a thermocouple lodged in a thermocouple lodging (19); the injection nozzle body (1) comprises at least two individual channels that are aligned with manifold (15) outlets.

The hot runner nozzle system has a nozzle tip assembly (16) adjacent to the injection nozzle body (1), wherein the nozzle tip assembly (16) comprises:
an adapter plate (3) comprising channeling elements;
a lock nut (4) suitable to fix the nozzle tip assembly (16) in place;
an inner insert (5) comprising additional channeling.

The hot runner nozzle system further comprises an obturator/check valve (7) housed in a common channel between the injection nozzle body (1) and the nozzle tip assembly (16).

In a preferred embodiment, the hot runner nozzle system comprises two individual channels (9, 10) that are aligned with two manifold (15) outlets.

In one embodiment, the shape of the obturator/check valve (7) is selected from spherical or cylindrical. However, the shape can be any other shape that is suitable to slide towards either melt stream port according to the pressure exerted by each.

In one embodiment, the nozzle tip assembly (16) further comprises a polymeric cap (6) suitable for providing compensation for thermal expansion of the nozzle tip assembly (16).

### Embodiment for Lateral Injection Delivery

In another embodiment as shown in FIGS. 8 to 10 co-injection melt streams can be delivered laterally into the cavity. This feature permits one injection nozzle body (1) to house a plurality of nozzle tips assemblies (16) according to the best angle and system shape and disposition for the molding tool design, each nozzle tips assembly (16) being arranged at an angle in relation to the injection nozzle body (1). In one embodiment, the angle between the injection nozzle body (1) and the nozzle tips assemblies (16) is between 1 and 90°.

Rectangular, circular, triangular are some, among others, possible system shapes and dispositions made available to the tool designer. In essence this embodiment has the same parts which are, the injection nozzle body (1), heating element (2) that is fixed by a circlip (8), N number of nozzle tip assemblies (16) and a corresponding number of obturators/check valves (7). N being a number between 2 and 4.

To complete this, the embodiment counts on an additional manifold attachment (17) and a centering ring (18) suitable to provide the connection between the injection nozzle body (1) and the N number of nozzle tip assemblies (16). The manifold attachment (17) comprises adequate channels for the melt streams as well as heating and temperature control elements. The flow and delivery of melt stream is as described in the preferred embodiment.

In this embodiment, the hot runner nozzle system of the present invention has an injection nozzle body (1) encompassed by a heating element (2) that is fixed by a circlip (8) and comprises a thermocouple lodged in a thermocouple lodging (19); the injection nozzle body (1) comprises at least two individual channels that are aligned with manifold (15) outlets.

The hot runner nozzle system has an N number of nozzle tip assemblies (16) adjacent to the injection nozzle body (1), wherein each nozzle tip assembly (16) comprises:
an adapter plate (3) comprising channeling elements;
a lock nut (4) suitable to fix the nozzle assembly (16) in place;
an inner insert (5) comprising additional channeling.

The hot runner nozzle system further comprises an obturator/check valve (7) housed in a common channel between the injection nozzle body (1) and each of the nozzle tip assemblies (16), one obturator/check valve (7) per nozzle tip assembly (16).

Each nozzle tip assembly (16) is arranged at an angle that varies between 1 and 90° in relation to the injection nozzle body (1).

The hot runner nozzle system further comprises an additional manifold attachment (17) comprising channels for melt streams, heating and temperature control elements.

The hot runner nozzle system further comprises a centering ring (18) connecting the injection nozzle body (1) to all the nozzle tip assemblies (16).

In a preferred embodiment, the hot runner nozzle system comprises two individual channels (9, 10) that are aligned with manifold (15) outlets.

In one embodiment, the shape of the obturator/check valve (7) is selected from spherical, cylindrical. However, the shape can be any other shape that is suitable to slide towards either melt stream port according to the pressure exerted by each.

In one embodiment, the nozzle tip assembly (16) further comprises a polymeric cap (6) suitable for providing compensation for thermal expansion of the nozzle tip assembly (16).

### Preferred Embodiment with Needle-Valve

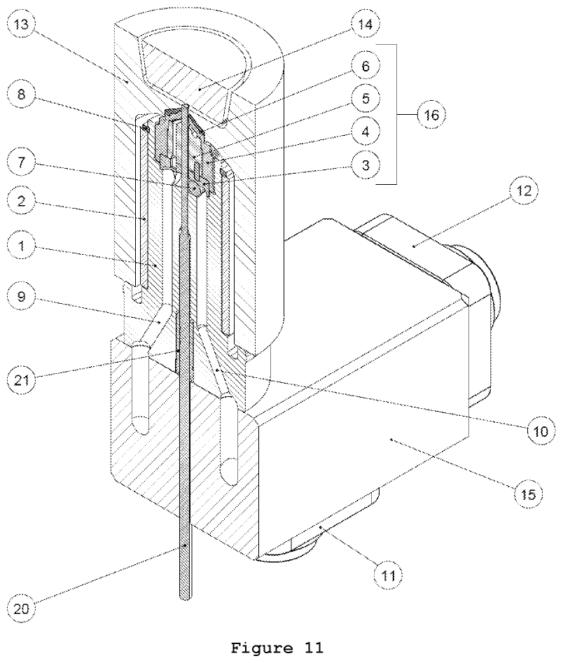

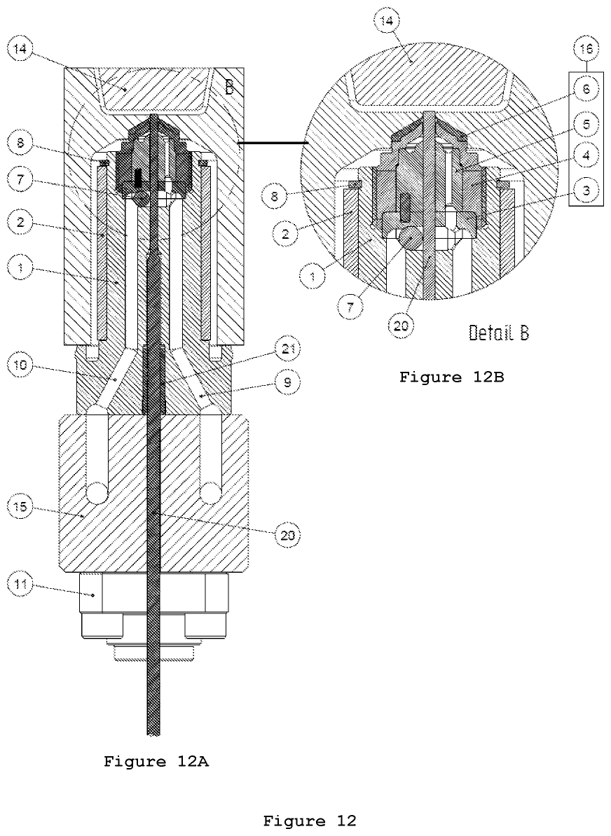

Sometimes the product requires a better appearance and the injection point to be imperceptible. This requires the invention to incorporate a needle-valve (20) and such an application is shown in FIGS. 11 and 12. This embodiment maintains the general characteristics of the obturator/check valve (7) to contain the mutual contamination of either melt stream. The needle-valve (20) has a back-and-forth motion which will respectively open to allow free flow of the melt streams and forward to block the gate to the molding cavity (13) (as shown in FIGS. 11 and 12). This will result in an almost imperceptible injection mark on the final molded product. The needle motion requires an actuating device providing a two-layer flow at the injection gate and for only two positions, open and shut, and is usually provided by a hydraulic or pneumatic cylinder. The injection nozzle body (1), adapter plate (3) and the inner insert (5) are modified to accommodate the needle-valve (20). A needle guide bushing (21) is fitted on the injection nozzle body (1) to simplify manufacturing and maintenance.

In this embodiment, the hot runner nozzle system of the present invention has an injection nozzle body (1) enveloped by a heating element (2) that is fixed by a circlip (8) and comprises a thermocouple lodged in a thermocouple lodging (19); the injection nozzle body (1) comprises at least two individual channels that are aligned with manifold (15) outlets.

The hot runner nozzle system has a nozzle tip assembly (16) adjacent to the injection nozzle body (1), wherein the nozzle tip assembly (16) comprises:
an adapter plate (3) comprising channeling elements;
a lock nut (4) suitable to fix the nozzle assembly in place;
an inner insert (5) comprising additional channeling.

The hot runner nozzle system further comprises an obturator/check valve (7) housed in a common channel between the injection nozzle body (1) and the nozzle tip assembly (16).

The hot runner nozzle system further comprises a needle-valve (20) and a needle guide bushing (21) inside the injection nozzle body (1) and the nozzle tip assembly (16) and an actuating device.

In a preferred embodiment, the hot runner nozzle system comprises two individual channels (9, 10) that are aligned with two manifold (15) outlets.

In one embodiment, the shape of the obturator/check valve (7) is selected from spherical, cylindrical. However, the shape can be any other shape that is suitable to slide towards either melt stream port according to the pressure exerted by each.

In one embodiment, the nozzle tip assembly (16) further comprises a polymeric cap (6) suitable for providing compensation for thermal expansion of the nozzle tip assembly (16).

### Embodiment with Needle-Valve and a Three-Layer Injection Stream

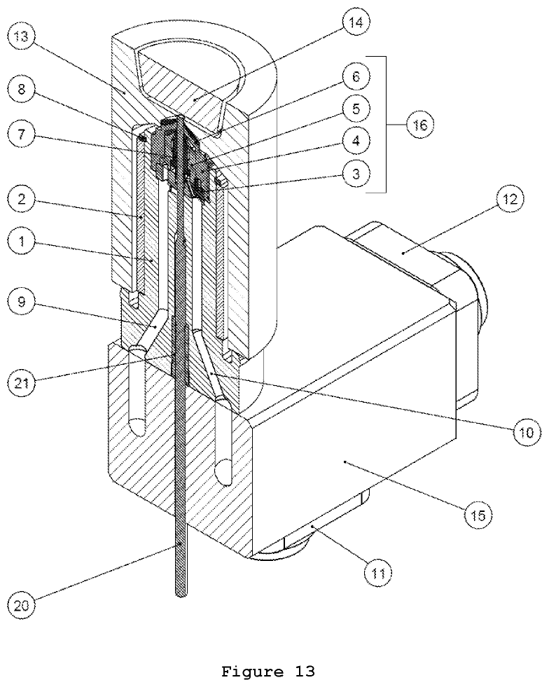

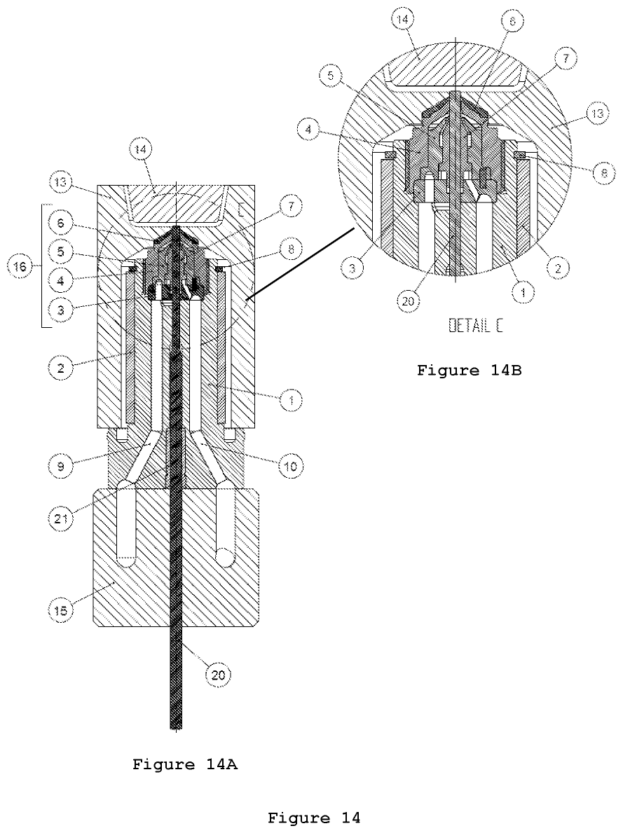

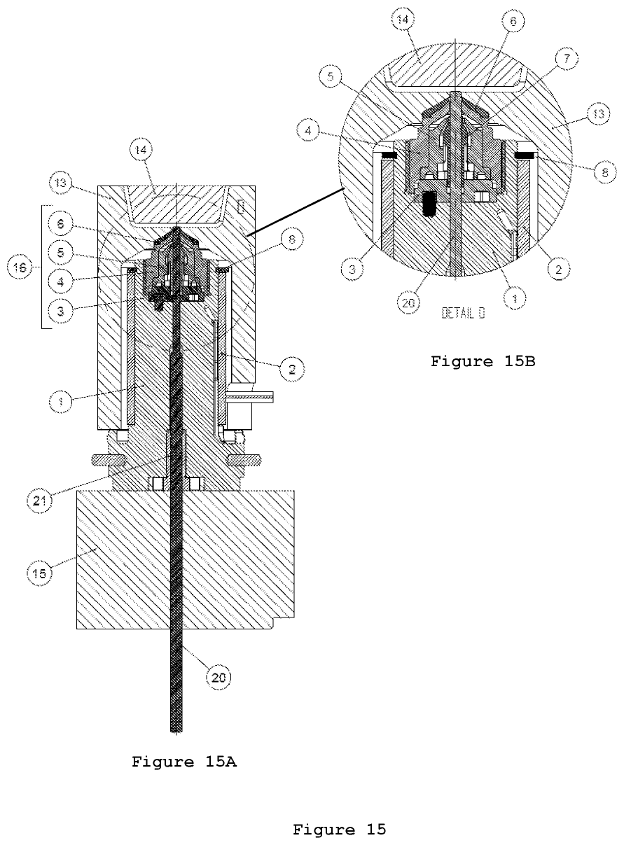

In this embodiment there are three distinct channels feeding the cavity gate with the melt stream as shown in FIG. 13, to 16. Outer and central channels are normally used for the melt stream providing the skin of the product and the intermediate channel for the core. As is shown in all the embodiments, this embodiment also provides an obturator/check valve (6) albeit of a different shape as shown in FIG. 13. Besides the before stated components the obturator/check valve (7) is provided with channeling for the intermediate layer core material melt stream. The obturator/check valve (7) that slides back and forth to avoid mutual contamination of the different streams and is driven by the difference in pressure between the skin and core melt streams. Thickness and relative position of the core can be controlled by varying the section of each channel delivering the melt streams. This is a fixed ratio after the manufacture of the system. The needle-valve (20) is allowed two or more positions, open, shut (position shown in the figures) or an intermediate one, and its application is optional. The use of the needle-valve (20) is defined by the product parameters and the control necessary for achieving the desired outcome. However, as in all previous embodiment descriptions, this embodiment contemplates a unique obturator/check valve (7) which will prevent the mutual contamination of the melt streams.

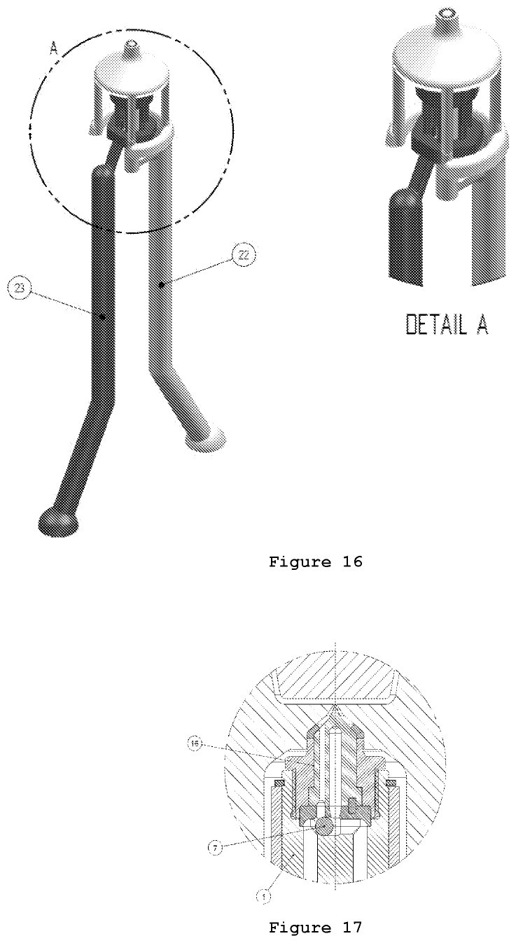

In this embodiment, the hot runner nozzle system of the present invention has an injection nozzle body (1) enveloped by a heating element (2) that is fixed by a circlip (8) and comprises a thermocouple lodged in a thermocouple lodging (19) ; the injection nozzle body (1) comprises two individual channels that are aligned with manifold (15) outlets. Entering the injection nozzle tip assembly (16), they will be further divided in three flows; a first melt stream (23) (the skin material) flows through the center and outer perimeter of the nozzle tip assembly (16) and a second melt stream (22) (the core material) flows around the obturator/check valve (7), as shown in FIG. 16.

The hot runner nozzle system has a nozzle tip assembly (16) adjacent to the injection nozzle body (1), wherein the nozzle tip assembly (16) comprises:
an adapter plate (3) comprising channeling elements;
a lock nut (4) suitable to fix the nozzle assembly in place;
an inner insert (5) comprising additional channeling.

The hot runner nozzle system further comprises an obturator/check valve (7) housed in a common channel between the injection nozzle body (1) and the nozzle tip assembly (16).

The hot runner nozzle system further comprises a needle-valve (20) and a needle guide bushing (21) inside the injection nozzle body (1) and the nozzle tip assembly (16) and an actuating device.

In a preferred embodiment, the hot runner nozzle system comprises two individual channels that are aligned with manifold (15) outlets.

In one embodiment, the shape of the obturator/check valve (7) is selected from cylindrical with a round or conical extremity.

In one embodiment, the nozzle tip assembly (16) further comprises a polymeric cap (6) suitable for providing compensation for thermal expansion of the nozzle tip assembly (16).

### Index

1. Injection Nozzle body
2. Heating element
3. Adapter plate
4. Lock Nut
5. Inner insert
6. Polymeric cap
7. Obturator/Check valve
8. Circlip
9. Inlet channel A
10. Inlet channel B
11. Sprue A
12. Sprue B
13. Cavity
14. Core
15. Hot runner manifold
16. Nozzle tip assembly
17. Manifold attachment
18. Centering ring
19. Thermocouple Lodging
20. Needle-valve
21. Needle guide bushing
22. Melt stream A
23. Melt stream B

1. A hot runner nozzle system suitable for co-injection molding comprising:
an injection nozzle body (1) enveloped by a heating element (2) that is fixed by a circlip (8) and comprises a thermocouple lodged in a thermocouple lodging (19);
the injection nozzle body (1) comprises at least two individual channels that are aligned with manifold (15) outlets for melt streams;
at least one nozzle tip assembly (16) adjacent to the injection nozzle body (1), wherein the at least one nozzle tip assembly (16) comprises:
an adapter plate (3) comprising channeling elements;
a lock nut (4) suitable to fix the nozzle tip assembly (16) in place;
an inner insert (5) comprising additional channeling;
an obturator/check valve (7) housed in a common channel between the injection nozzle body (1) and a nozzle tip assembly (16).

2. The hot runner nozzle system according to claim 1, wherein the injection nozzle body (1) comprises two individual channels (9, 10) that are aligned with two manifold (15) outlets.

3. The hot runner nozzle system according to claim 1, wherein the shape of the obturator/check valve (7) is selected from spherical, cylindrical, or cylindrical with a rounded or conical extremity.

4. The hot runner nozzle system according to claim 1, wherein the nozzle tip assembly (16) further comprises a polymeric cap (6) suitable for providing compensation for thermal expansion of the nozzle tip assembly (16).

5. The hot runner nozzle system according to claim 1, further comprising an N number of nozzle tip assemblies (16) between 2 and 4.

6. The hot runner nozzle system according to claim 5, wherein each nozzle tip assembly (16) is arranged at an angle between 1 and 90° in relation to the injection nozzle body (1).

7. The hot runner nozzle system according to claim 1, further comprising an additional manifold attachment (17) and a centering ring (18) suitable to provide the connection between the injection nozzle body (1) and the N number of nozzle tip assemblies (16).

8. The hot runner nozzle system according to claim 7, wherein the manifold attachment (17) comprises adequate channels for the melt streams as well as heating and temperature control elements.

9. The hot runner nozzle system according to claim 1, further comprising a needle-valve (20) and a needle guide bushing (21) inside the injection nozzle body (1) and the nozzle tip assembly (16).

10. The hot runner nozzle system according to claim 9, wherein the needle-valve (20) comprises an actuating device.

11. The hot runner nozzle system according to claim 1, wherein the injection nozzle body (1) and nozzle tip assembly (16) comprises additional channeling and a needle-valve suitable to provide a three-layer flow at the injection gate.
